(19) United States
(12) Patent Application Publication
(10) Pub. No.: US 2017/0181442 A1
(43) Pub. Date: Jun. 29, 2017

(54) Microwavable Pancake Mixes and Methods of Preparing Pancakes

(71) Applicant: Baker Mills Inc., Park City, UT (US)

(72) Inventors: Joel Clark, Midway, UT (US); Cameron Smith, Midway, UT (US); Cori Stevens, West Valley City, UT (US)

(21) Appl. No.: 15/384,695

(22) Filed: Dec. 20, 2016

Related U.S. Application Data
(60) Provisional application No. 62/271,498, filed on Dec. 28, 2015.

(51) Int. Cl. A21D 10/00

(52) U.S. Cl. CPC A21D 10/002

(57) ABSTRACT

Pancake mixes comprising at least one type of whole grain flour, at least one natural sweetener, at least one fat and a leavening system are provided herein. Packaged food products comprising single-serving containers containing said pancake mixes, as well as methods of preparing pancakes, are also provided. The pancakes described herein are preferably 100% whole grain and free from preservatives and/or artificial colorings.

### CROSS REFERENCE TO RELATED APPLICATIONS

The present invention claims priority under 35 U.S.C. § 119(e) to U.S. provisional application No. 62/271,498 filed Dec. 28, 2015, the entire contents of which is hereby incorporated herein by reference.

### FIELD OF THE INVENTION

The present invention relates generally to pancake mixes which, when combined with water and heated in the microwave, provide pancakes. The present invention further extends to packaged food products comprising single-serving containers containing such pancake mixes, as well as methods of preparing pancakes.

### BACKGROUND OF THE INVENTION

Pancakes are popular breakfast items. Pancakes are typically made by preparing a dry mix, adding liquid ingredients (e.g., water, milk) to make a batter, and then cooking portions of the batter on the griddle or in a pan. However, in today's busy world, many individuals do not have time to cook breakfast and enjoy the same at the table. Moreover, it is not efficient to prepare an entire batch of pancake mix when only a single pancake is desired.

Pre-made pancakes purchased from the frozen food section of the grocery store can elicit off-tastes and seem dry when re-heated. Moreover, the store-bought frozen pre-made pancakes are often low in nutritional content and contain a variety of artificial ingredients and/or preservatives.

Accordingly, there remains a need for single-serving, nutritional pancake mixes that can be prepared rapidly and have flavorsome organoleptic qualities.

### SUMMARY OF THE INVENTION

The present invention relates to pancake mixes comprising at least one type of whole grain flour, at least one natural sweetener, at least one fat and a leavening system. The pancake mixes are comprised of 100% whole grain flour and do not contain white flour. In preferred embodiments, the pancake mixes are free from preservatives and/or artificial colorings.

The pancake mix preferably comprises whole wheat flour and whole grain oat flour. The sweetener is preferably brownulated sugar, optionally in combination with dried honey. The leavening system is preferably baking soda and monocalcium phosphate. The fat is preferably palm oil flakes.

The pancake mixes may further comprise additional ingredients, e.g. milk products, protein sources, flavorings, fruit, and spices.

The present invention also relates to packaged food products comprising a single-serving container containing a pancake mix. In one embodiment, the single-serving container is selected from a cup, pouch, box or bag. The single-serving containers are made from microwavable materials and have a lid sealing the pancake mix in the single-serving container.

In a particular embodiment, the single-serving container is a cup. In a more particular embodiment, the single-serving container is a cup comprising a plastic lid sealing the pancake mix in the single-serving container.

The present invention also relates to methods of preparing pancakes. In one embodiment, a method of preparing a pancake comprises (i) providing a pancake mix of the present invention, (ii) providing water, (iii) adding the water to the pancake mix to provide a pancake batter, (iv) optionally, stirring the pancake batter and (v) microwaving the pancake batter for a sufficient time to provide a pancake. In some embodiments, the pancake batter in (iv) is stirred.

In another embodiment, a method of preparing a pancake comprises (i) providing a packaged food product comprising a single-serving container containing a pancake mix having a lid sealing said pancake mix within said single-serving container, wherein the pancake mix is present in an amount of about 60 g to about 65 g, (ii) providing water in an amount of about ¼ cup, (iii) removing the lid sealing said pancake mix within the single-serving container, (iv) adding the water to the pancake mix to provide a pancake batter, (v) optionally, stirring the pancake batter and (vi) microwaving the pancake batter in the single-serving container for between about 45 seconds and about 2 minutes to provide a pancake in the single-serving container. In some embodiments, the pancake batter in (v) is stirred.

In another embodiment, a method of preparing a pancake comprises (i) providing a packaged food product comprising a single-serving cup containing a pancake mix having a plastic lid sealing said pancake mix within said single-serving cup, wherein the pancake mix is present in an amount of about 60 g to about 65 g, (ii) providing water in an amount of about ¼ cup, (iii) removing the lid sealing said pancake mix within the single-serving cup, (iv) adding the water to the pancake mix to provide a pancake batter, (v) optionally, stirring the pancake batter and (vi) microwaving the pancake batter in the single-serving cup for between about 45 seconds and about 2 minutes to provide a pancake in the single-serving cup. In some embodiments, the pancake batter in (v) is stirred.

The present invention also relates to pancakes prepared by the methods provided herein.

### DETAILED DESCRIPTION OF THE INVENTION

### I. Pancake Mixes

The term “pancake mix”, as used herein, refers to the dry mix of ingredients that, when combined with water and heated, results in a pancake.

The term “pancake”, as used herein, refers to a thin, flat cake of batter. Pancake batter typically contains whole grain flour, water, sugar, fat and a leavening system. The term pancake is used synonymously with flapjack, hotcake and griddlecake, among others. The specific name varies depending on geography.

The pancake mix of the present invention comprises at least one type of whole grain flour, at least one natural sweetener, at least one fat and a leavening system. The pancake mix can further comprise additional components, described herein below.

The pancake mix of the present invention comprises at least one type of whole grain flour. In a particular embodiment, the pancake mix comprises two types of whole grain flour. In particularly desirable embodiments, the only flour(s) present in the pancake mix is whole grain flour(s), i.e. the pancake mix does not contain white flour.

“Whole grain flour,” as used herein, refers to flour that is formed by grinding entire kernels of a whole grain into flour. A whole grain flour may also include a composition in which the bran, endosperm and germ were separately processed or ground and the processed portions were recombined.

Suitable whole grain flours include, but are not limited to, flours from amaranth, barley, buckwheat, bulgur, corn, einkorn, faro, fonio, freekeh, kamut, kaniwa, millet (pearl millet (Pennisetum glaucum), foxtail millet (Setaria italica), proso millet (Panicum miliaceum), finger millet/ragi (Eleucine coracana), and fonio (Digitaria exilis)), oat, quinoa, rice, rye, sorghum, spelt, teff, triticale, wheat, wild rice and combinations thereof.

The amount of whole grain flour in the pancake mix is typically from about 40% to about 60% by weight on a dry basis, such as, for example, from about 40% to about 55%, from about 40% to about 50%, from about 40% to about 45%, from about 45% to about 60%, from about 45% to about 55%, from about 45% to about 50%, from about 50% to about 60% and from about 55% to about 60%.

In one embodiment, the pancake mix comprises whole wheat flour and whole grain oat flour.

The amount of whole wheat flour in the pancake mix is typically from about 30% to about 40% by weight on a dry basis, such as, for example, from about 30% to about 35% and from about 35% to about 40%.

The amount of whole grain oat flour in the pancake mix is typically from about 10% to about 20%, such as, for example, about 10% to about 15% and about 15% to about 20%. In another embodiment, the pancake mix comprises whole grain oat flour in an amount of about 10%, about 11%, about 12%, about 13%, about 14%, about 15%, about 16%, about 17%, about 18% or about 19%.

In one embodiment, the pancake mix comprises whole wheat flour and whole grain oat flour in a combined amount of about 40% to about 60% by weight on a dry basis. In a more particular embodiment, the pancake mix comprises whole wheat flour and whole grain oat flour in a combined amount of about 40% to about 60% by weight on a dry basis, wherein whole wheat flour is present in an amount from about 30% to about 40% by weight on a dry basis and whole grain oat flour is present in an amount from about 10% to about 20% by weight on a dry basis.

The pancake mix of the present invention also comprises a natural sweetener. Suitable sweeteners include, but are not limited to, agave, barley malt syrup, brown rice syrup, cane sugar, muscovado sugar, turbinado sugar, demerara sugar, coconut sugar, date sugar, honey, molasses, sugar alcohols (e.g. erythritol, maltitol, mannitol, sorbitol, and xylitol). In other embodiments, the natural sweetener is a sugar. Suitable sugars include, but are not limited to, pentoses such as fructose, xylose, arabinose, glucose, galactose, amylose, fructose, sorbose, lactose, maltose, dextrose, sucrose, maltodextrins, molasses, brown sugar, brownulated sugar and combinations thereof.

The amount of natural sweetener in the pancake mix will depend on the identity of the natural sweetener. Typically, the pancake mix comprises a natural sweetener in an amount from about 5% to about 10% by weight on a dry basis, such as, for example, about 5%, about 6%, about 7%, about 8%, about 9% or about 10%.

In one embodiment, the natural sweetener comprises brownulated sugar. In another embodiment, the natural sweetener comprises a combination of brownulated sugar and brown sugar. In still another embodiment, the natural sweetener comprises a combination of brownulated sugar and dried honey.

The brownulated sugar is typically present in the pancake mix in an amount from about 5% to about 10%, such as, for example, about 5%, about 6%, about 7%, about 8%, about 9% or about 10%.

The pancake mix of the present invention also comprises a leavening system. “Leavening system”, as used herein, refers to a mixture, usually at least one acid and one base, that react to form carbon dioxide, thereby causing the pancake to rise. Compounds that promote leavening are well known in the art and include, but are not limited to, baking soda (sodium bicarbonate or potassium bicarbonate), monocalcium phosphate monohydrate (MCP), (MCP), sodium acid pyrophosphate (SAPP), sodium aluminum phosphate (SALP), dicalcium phosphate dihydrate (DPD), dicalcium phosphate (DCP), sodium aluminum sulfate (SAS), glucono-deltalactone (GDL), potassium hydrogen tartrate (cream of tartar) and combinations thereof

In one embodiment, the leavening system comprises baking soda. In a more particular embodiment, the leavening system comprises baking soda and monocalcium phosphate. In a still more particular embodiment, the leavening system consists of baking soda and monocalcium phosphate.

Typically, the pancake mix comprises the leavening system in an amount from about 0.5% to about 3.5% by weight on a dry basis, such as, for example, from about 0.5% to about 3%, from about 0.5% to about 2.5%, from about 0.5% to about 2%, from about 0.5% to about 1.5%, from about 1.5% to about 1%, from about 1% to about 3.5%, from about 1% to about 3%, from about 1% to about 2.5%, from about 1% to about 2%, from about 1.5% to about 3.5%, from about 1.5% to about 3%, from about 1.5% to about 2.5%, from about 1.5% to about 2%, from about 2% to about 3.5%, from about 2% to about 3%, from about 2% to about 2.5%, from about 2.5% to about 3% and from about 3% to about 3.5%.

In a particular embodiment, the pancake mix comprises the leavening system in an amount from about 1.5% to about 2.5% by weight on a dry basis, such as, for example, about 1.5%, about 1.7%, about 1.9% and about 2.1%.

The pancake mix of the present invention also comprises a fat. Suitable fats include, but are not limited to, oils such as cottonseed oil, nut oil, soybean oil, sunflower oil, rapeseed oil, sesame oil, olive oil, corn oil, safflower oil, palm oil, palm kernel oil, coconut oil, and combinations thereof.

Typically, the pancake mix comprises fat in an amount from about 5% to about 13%, such as, for example, from about 5% to about 10%, about 7% to about 12% or about 10% to about 15%.

In a particular embodiment, the fat comprises palm oil. In a more particular embodiment, the fat comprises palm oil flakes. In an even more particular embodiment, the fat consists of palm oil flakes.

Palm oil flakes have been found to affect both the taste and rising characteristics of the pancake mix. Use of palm oil results in a pancake that does not rise consistently and causes the pancake to “fall”. The pancake falls regularly when water is added to the pancake mix in amounts larger than the advised amount. Use of palm oil flakes, in contrast, results in a pancake that rises consistently—even when larger water amounts are added to the pancake mix. Not wishing to be bound by theory, palm oil flakes also provide richness to the pancake, and allow for reduced pancake sugar content.

The pancake mix of the present invention may further comprise maple syrup flakes. Use of maple syrup flakes is preferable to maple syrup flavoring and/or maple syrup pellets (the latter comprising palm oil, sugar and maple flavoring). Maple syrup flakes provide discrete pockets of maple flavor—as in traditional pancake preparation, whereas maple flavoring and maple syrup pellets provides a more homogenous dispersal of maple flavor throughout the pancake.

Typically, the pancake mix comprises maple syrup flakes in an amount from about 10% to about 15% by weight on a dry basis, such as, for example, about 10%, about 11%, about 12%, about 13%, about 14% or about 15%.

The pancake mix of the present invention may further comprise milk solids. “Milk solids”, as used herein, refers to dried milk following evaporation of water. In some cases additional substances are also removed, e.g. non-protein constituents. Suitable milk solids include, but are not limited to, dried milk including non-fat dried milk, milk protein isolates and combinations thereof.

Typically, the pancake mix comprises milk solids in an amount from about 1% to about 8% by weight on a dry basis, such as, for example, from about 2% to about 6% or about 3% to about 5%.

The pancake mixes of the present invention may further comprise whey protein concentrate. Typically, the pancake mix comprises whey protein concentrate in an amount from about 0.5% to about 5% by weight on a dry basis, depending on the desired protein content. In protein-enriched pancake mixes, the whey protein concentrate can be present in an amount of at least 3% by weight on a dry basis. In more typical pancake mixes, the wheat protein isolate can be present in an amount from about 0.5% to about 1% by weight on a dry basis.

The pancake mixes of the present invention may also further comprise wheat protein isolate. Typically, the pancake mix comprises wheat protein isolate in an amount from about 0.5 to about 10% by weight, depending on the desired protein content. In protein-enriched pancake mixes, the wheat protein isolate can be present in an amount of at least 5% by weight on a dry basis. In more typical pancake mixes, the wheat protein isolate can be present in an amount from about 0.5% to about 3% by weight on a dry basis.

The pancake mixes of the present invention may also further comprise fruit, typically dried fruit. Suitable fruit includes, but is not limited to, acai, apples, apricots, bananas, bilberries, blackberries, blueberries, boysenberries, camu camu, cantaloupes, cherries, chokeberries, coconuts, cranberries, dates, elderberries, figs, goji berries, gooseberries, guava, jackfruit, kiwis, lemons, lucuma, mangos, mangosteens, maquis, mulberries, nectarines, noni, oranges, dragon fruits, papayas, peaches, pears, persimmons, pineapples, plums, pluots, pomegranates, raisins, raspberries, star fruits, strawberries and combinations thereof.

The amount of fruit in the pancake mix can vary depending on the fruit and the desired taste. Typically, the pancake mix comprises fruit in an amount from about 0.5% to about 5% by weight on a dry basis, such as, for example, about 1%, about 2%, about 3%, about 4% and about 5%.

In addition to the foregoing, other ingredients known to those of skill in the art can be included in the pancake mixes to give a variety of desired properties, flavors and/or textures. Examples of these ingredients include flavoring and coloring agents, flavors, such as vanilla flavor, butter flavor, buttermilk powder, and spices, such as salt and cinnamon. Suitable amounts of flavoring and coloring agents, flavors and spices include 0.1-3% by weight of the pancake mix on a dry basis.

In one embodiment, a pancake mix comprises at least one type of whole grain flour, at least one natural sweetener, at least one fat and a leavening system.

In a more particular embodiment, a protein-enriched pancake mix comprises at least one type of whole grain flour, at least one natural sweetener, at least one fat and a leavening system, wherein the protein content of the pancake mix is at least 9% by weight on a dry basis. The protein content can comprise milk solids, whey protein concentrate and wheat protein isolate.

In a particular embodiment, the at least one type of whole grain flour comprises a combination of whole wheat flour and whole grain oat flour; the at least one natural sweetener comprises brownulated sugar and dry honey, the at least one fat comprises palm oil flakes and the leavening system comprises baking soda and monocalcium phosphate. In some embodiment, the pancake mix further comprises flavors and spices, such as, for example, butter flavor, maple flakes and salt.

In another embodiment, a maple-flavored pancake mix comprises at least one type of whole grain flour, at least one natural sweetener, at least one fat, maple syrup flakes and a leavening system.

In a particular embodiment, the at least one type of whole grain flour comprises a combination of whole wheat flour and whole grain oat flour, the at least one natural sweetener comprises brownulated sugar and dry honey, the at least one fat comprises palm oil flakes and the leavening system comprises baking soda and monocalcium phosphate. In some embodiment, the pancake mix further comprises cinnamon flakes and/or dried blueberries.

### II. Containers

The present invention also provides a packaged food product comprising a single-serving container containing a pancake mix of the present invention. Any of the pancake mixes described herein above can be used. The single-serving containers typically comprise between about 60 and about 65 g of the pancake mix. A suitable single-serving container includes, but is not limited to, a cup, pouch, box or bag. A lid seals the pancake mix within the single-serving container. The single-serving container can be made from any microwavable material.

In one embodiment, the single-serving container is a single-serving cup. The top and bottom of the single-serving cup are typically flat, and the side of the container is rounded. In some embodiments, a plastic lid seals the pancake mix within the single-serving cup. The single-serving cup can be made from any microwavable material, such as, for example, paper or paper board. The single-serving cup is optionally lined with polypropylene, polyethylene or a combination thereof.

Typically, the single-serving cup is between about 3 and about 4 inches high, such as, for example, about 3.25 inches, about 3.50 inches or about 3.75 inches. In a preferred embodiment the single-serving cup is about 3.25 inches high.

The outer diameter of the top of the single-serving cup is typically from about 3 to about 4.0 inches wide, such as, for example, from about 3.0 to about 3.75 inches, from about 3.0 to about 3.5 inches, from about 3.0 to about 3.25, from about 3.25 to about 4.0 inches, from about 3.25 to about 3.75 inches, from about 3.25 to about 3.5 inches, from about 3.5 to about 4.0 inches, from about 3.5 to about 3.75 inches and from about 3.75 to about 4.0 inches. In a preferred embodiment, the outer diameter is from about 3.5 to about 3.75 inches.

The outer diameter of the bottom of the single-serving cup is typically from about 2.0 to about 3.0 inches, such as, for example, from about 2.0 to about 2.75 inches, from about 2.0 to about 2.5 inches, from about 2.0 to about 2.25 inches, from about 2.25 to about 3 inches, from about 2.25 to about 2.75 inches, from about 2.25 to about 2.5 inches, from about 2.5 to about 3.0 inches, from about 2.5 to about 2.75 inches and from about 2.75 inches to about 3 inches. In a preferred embodiment, the outer diameter is from about 2.75 to about 3 inches.

### III. Pancakes and Methods of Preparing Pancakes

The present invention also provides a method of preparing a pancake. In one embodiment, a method of preparing a pancake comprises (i) providing a pancake mix of the present invention, (ii) providing water, (iii) adding the water to the pancake mix to provide a pancake batter, (iv) optionally, stirring the pancake batter and (v) microwaving the pancake batter for a sufficient time to provide a pancake. In particular embodiments, the pancake batter in (iv) is stirred.

“Pancake batter”, as used herein, refers to wetted pancake mix, i.e. pancake mix and water.

Any pancake mix disclosed herein above can be used in the method.

The amount of water added is usually between ⅕ and ⅓ of a cup, typically around ¼ of a cup, per 60-65 g of pancake mix. This same ratio of water to pancake mix can be used depending on the amount of pancake mix.

The amount of time required to heat the pancake batter in the microwave varies depending on microwave power. Typically, the pancake batter is headed in the microwave on normal power for from about 45 seconds to about 2 minutes, such as, for example, about 1 minute or about 1.5 minutes.

In a particular embodiment, a method of preparing a pancake comprises (i) providing a pancake mix of the present invention in an amount of about 60 to about 65 g, (ii) providing water in an amount of about ¼ cup, (iii) adding the water to the pancake mix to provide a pancake batter, (iv) optionally, stirring the pancake batter and (v) microwaving the pancake batter for between about 45 seconds and about 2 minutes to provide a pancake.

In another embodiment, a method of preparing a pancake comprises (i) providing a packaged food product comprising a single-serving container containing a pancake mix having a lid sealing said pancake mix within said single-serving container, wherein the pancake mix is present in an amount of about 60 g to about 65 g, (ii) providing water in an amount of about ¼ cup, (iii) removing the lid sealing said pancake mix within the single-serving container, (iv) adding the water to the pancake mix to provide a pancake batter, (v) optionally, stirring the pancake batter and (vi) microwaving the pancake batter in the single-serving container for between about 45 seconds and about 2 minutes to provide a pancake in the single-serving container.

In a more particular embodiment, a method of preparing a pancake comprises (i) providing a packaged food product comprising a single-serving cup containing a pancake mix having a plastic lid sealing said pancake mix within said single-serving cup, wherein the pancake mix is present in an amount of about 60 g to about 65 g, (ii) providing water in an amount of about ¼ cup, (iii) removing the lid sealing said pancake mix within the single-serving cup, (iv) adding the water to the pancake mix to provide a pancake batter, (v) optionally, stirring the pancake batter and (vi) microwaving the pancake batter in the single-serving cup for between about 45 seconds and about 2 minutes to provide a pancake in the single-serving cup. In a particular embodiment, the pancake batter in (v) is stirred.

The pancakes of the present invention, prepared by the methods above, are superior to store-bought frozen pancakes as found in the grocery store. The pancakes of the present invention are moist. The pancakes of the present invention made from 100% whole-grain flour. In some embodiments, the pancakes of the present invention do not contain preservatives and/or artificial colorings.

Pancakes prepared by the methods herein above are typically about 2 to about 3 inches high, such as, for example, from about 2.0 to about 2.75 inches, from about 2.0 to about 2.5 inches, from about 2.0 to about 2.25 inches, from about 2.25 to about 3.0 inches, from about 2.25 to about 2.75 inches, from about 2.25 to about 3.0 inches, from about 2.5 to about 3.0 inches, from about 2.5 to about 2.75 inches and from about 2.75 to about 3.0 inches. In a preferred embodiment, the pancake is typically about 2.5 inches high.

In one embodiment, the present invention is a pancake comprising at least one type of whole grain flour, at least one natural sweetener, at least one fat, a leavening system and water. The pancake can be fruit-flavored and/or mayple syrup-flavored. In one embodiment, the pancake is blueberry and maple-flavored. In another embodiment, the pancake is cinnamon and maple-flavored.

In a more particular embodiment, a protein-enriched pancake comprises at least one type of whole grain flour, at least one natural sweetener, at least one fat, a leavening system, and water. The protein content can comprise milk solids, whey protein concentrate and wheat protein isolate.

In a particular embodiment, the at least one type of whole grain flour comprises a combination of whole wheat flour and whole grain oat flour; the at least one natural sweetener comprises brownulated sugar and dry honey, the at least one fat comprises palm oil flakes and the leavening system comprises baking soda and monocalcium phosphate. In some embodiment, the pancake further comprises flavors and spices, such as, for example, butter flavor, maple flakes and salt.

In another embodiment, a maple-flavored pancake comprises at least one type of whole grain flour, at least one natural sweetener, at least one fat, maple syrup flakes, a leavening system and water.

In a particular embodiment, the at least one type of whole grain flour comprises a combination of whole wheat flour and whole grain oat flour; the at least one natural sweetener comprises brownulated sugar and dry honey, the at least one fat comprises palm oil flakes and the leavening system comprises baking soda and monocalcium phosphate. In some embodiments, the pancake further comprises cinnamon and/or dried blueberries.

1. A packaged food product comprising a single-serving container and a pancake mix comprising at least one type of whole grain flour, at least one natural sweetener and at least one fat and a leavening system, wherein the pancake mix is free from white flour.

2. The packaged food product of claim 1, wherein the at least one type of whole grain flour is selected from the group consisting of flours from amaranth, barley, buckwheat, bulgur, corn, einkorn, faro, fonio, freekeh, kamut, kaniwa, millet (pearl millet (Pennisetum glaucum), foxtail millet (Setaria italica), proso millet (Panicum miliaceum), finger millet/ragi (Eleucine coracana), and fonio (Digitaria exilis)), oat, quinoa, rice, rye, sorghum, spelt, teff, triticale, wheat, wild rice and combinations thereof

3. The packaged food product of claim 2, wherein the at least one type of whole grain flour comprises whole wheat flour and whole grain oat flour.

4. The packaged food product of claim 1, wherein the pancake mix is free from preservatives and/or artificial colorings.

5. The packaged food product of claim 1, wherein the at least one natural sweetener is selected from the group consisting of agave, barley malt syrup, brown rice syrup, cane sugar, muscovado sugar, turbinado sugar, demerara sugar, coconut sugar, date sugar, honey, molasses, sugar alcohols (e.g. erythritol, maltitol, mannitol, sorbitol, and xylitol), pentoses such as fructose, xylose, arabinose, glucose, galactose, amylose, fructose, sorbose, lactose, maltose, dextrose, sucrose, maltodextrins, molasses, brown sugar, brownulated sugar and combinations thereof

6. The packaged food product of claim 5, wherein the at least one natural sweetener comprises brownulated sugar and, optionally, brown sugar and/or dried honey.

7. The packaged food product of claim 5, wherein the at least one natural sweetener is present in an amount from about 5% to about 10% by weight on a dry basis.

8. The packaged food product of claim 1, wherein the at least one fat is selected from cottonseed oil, nut oil, soybean oil, sunflower oil, rapeseed oil, sesame oil, olive oil, corn oil, safflower oil, palm oil, palm kernel oil, coconut oil, and combinations thereof.

9. The packaged food product of claim 8, wherein the at least one fat is palm oil in the form of palm oil flakes.

10. The packaged food product claim 8, wherein the at least one fat is present in an amount from about 5% to about 13% by weight on a dry basis.

11. The packaged food product of claim 1, wherein the leavening system comprises baking soda and monocalcium phosphate.

12. The packaged food product of claim 1, wherein the pancake mix further comprises maple syrup flakes.

13. The packaged food product of claim 12, wherein the maple syrup flakes are present in an amount from about 10% to about 15% by weight on a dry basis.

14. The packaged food product of claim 1, wherein the pancake mix further comprises whey protein concentrate and/or wheat protein isolate.

15. The packaged food product of claim 1, wherein the single-serving container contains from about 60 g to about 65 g of the pancake mix.

16. The packaged food product of claim 1, wherein the single-serving container is selected from a cup, pouch, bag or box.

17. The packaged food product of claim 16 wherein the single-serving container is a cup and the pancake mix is sealed within the cup.

18. The packaged food product of claim 17, wherein the cup is between about 3 and about 4 inches high.

19. The packaged food product of claim 18, wherein the outer diameter of the top of the cup is about 3 to about 4 inches wide.

20. The packaged food product of claim 19, wherein the outer diameter of the bottom of the cup is from about 2 to about 3 inches wide.
